(19) United States
(12) Patent Application Publication
(10) Pub. No.: US 2007/0033395 A1
(43) Pub. Date: Feb. 8, 2007

(54) Method and system for hierarchical license servers

(75) Inventor: Kirk A. MacLean, Pleasanton, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Macrovision

(21) Appl. No.: 11/195,314

(22) Filed: Aug. 2, 2005

(51) Int. Cl. H04L 9/00

(52) U.S. Cl. 713/157

(57) ABSTRACT

A method and system for hierarchical license servers is disclosed. According to one embodiment, a computer implemented method comprises receiving license requests from a plurality of clients. The license requests are serviced using a plurality of mini servers, each mini server serving licenses to a client of the plurality of clients in response to a license request of the license requests. A primary license server provides the licenses to the plurality of mini servers.

### FIELD OF THE INVENTION

The field of the invention relates generally to computer systems and more particularly relates to a method and system for hierarchical license servers.

### BACKGROUND OF THE INVENTION

Generally, when software is sold, the purchaser is granted a license to use the software. Such a license imposes restrictions on the number of computers that can be used simultaneously, the term of use, the number of users allowed to use the software simultaneously in the case of a multi-user system, etc.

In recent years, however, illegal use of software beyond the restrictions imposed by license has become an object of public concern. For example, most software on the market permits only one computer to run the software, in a clause of the license. However, if the software has no illegal use prevention function incorporated therein, the software can readily be used on numerous computers.

Various techniques have therefore been developed to prevent illegal use of software. Some of such techniques use computer-specific identification information. Commercial software that is licensed using capacity-related metrics often includes or operates with validation systems that validate whether the software is running in environments which are compliant with current licensing terms and conditions. The commercial software may use a commercially available software application known in the art as a “license manager,” such as ISOGON'S IFOR or Macrovision's FLEX-LM, that uses a “license key” to unlock at least one component of the commercial software. Some electronic form of the license, typically, is evaluated and a license key is provided for the validation system to audit and control the commercial software in accordance with the commercial software licensing terms and conditions.

As license management software permeates throughout enterprises, existing license server architectures and topographies have failed to meet the demands.

### SUMMARY

A method and system for hierarchical license servers is disclosed. According to one embodiment, a computer implemented method comprises receiving license requests from a plurality of clients. The license requests are serviced using a plurality of mini servers, each mini server serving licenses to a client of the plurality of clients in response to a license request of the license requests. A primary license server provides the licenses to the plurality of mini servers.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates a block diagram of an exemplary software license management systems, according to one embodiment of the present invention;

FIG. 2 illustrates an exemplary computer architecture for use with the present system, according to one embodiment of the invention;

FIG. 3 illustrates a block diagram of an exemplary license server hierarchy, according to one embodiment of the present invention;

FIG. 4 illustrates a block diagram of an exemplary license server hierarchy 400 with mini-server groups, according to one embodiment of the present invention;

FIG. 5 illustrates a block diagram of an exemplary license borrowing system 500, according to one embodiment of the present invention;

FIG. 6 illustrates a block diagram of a license server hierarchy 600 having a vendor controlled license server, according to one embodiment of the present invention;

FIG. 7 illustrates a block diagram of an exemplary redundant server architecture 700, according to one embodiment of the present invention;

FIG. 8 illustrates a block diagram of an exemplary redundant server architecture 800 having a dongle 830, according to one embodiment of the present invention;

FIG. 9 illustrates a block diagram of an exemplary redundant server architecture having a vendor license server, according to one embodiment of the present invention;

FIG. 10 illustrates a block diagram of an exemplary redundant server architecture having a redundant vendor server group, according to one embodiment of the present invention;

FIG. 11 illustrates a block diagram of an exemplary redundant server architecture having a redundant vendor server group and a redundant customer license server group, according to one embodiment of the present invention; and

FIG. 12 illustrates a flow chart of an exemplary process for hierarchical license serving, according to one embodiment of the present invention.

### DETAILED DESCRIPTION

A method and system for hierarchical license servers is disclosed. According to one embodiment, a computer implemented method comprises receiving license requests from a plurality of clients. The license requests are serviced using a plurality of mini servers, each mini server serving licenses to a client of the plurality of clients in response to a license request of the license requests. A primary license server provides the licenses to the plurality of mini servers.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

As used herein, the following terms shall have the following meanings without regard to its upper or lower case usage.

“Back-end” refers to a server, computer or system under the control or otherwise authorized by a software Vendor to receive and process information received from a Customer of its usage of software licensed to the Customer by the Vendor.

“Customer” means a licensee of licensed software.

“File” refers to what is generally understood as a computer file, but as used here also includes any system for storing and retrieving digital data, inclusive of database managers, registries, directories and data objects.

“Front-end” refers to a server, computer or system under the control or otherwise authorized by a Customer to execute, manage and/or report usage of software licensed to the Customer.

“License applet” means a mini server loaded on a client system to support borrowed licenses.

“Master server” refers to the only license server in a redundant server configuration that is allowed to grant license requests. Should this master fail then the other redundant servers will negotiate to determine which one becomes the new master.

“Mini server” means the server at the customer's site that connects to the primary license server and is the central point for all clients to connect to and check out licenses.

“Primary license server” means the server at the customer's site, that may be under the customer's control. It will perform some or all of the following actions depending on the configuration:

It is the central point for all mini servers to connect to and make licensing requests.

Connects to the license server at the vendor site (if it exists) to retrieve the licenses.

Read the local license files.

Serve licenses to client applications.

“Secondary server” means a license server in a redundant server configuration that is not allowed to grant licenses because it is only a mirror of the master server.

“Server” means a computer process that other computer applications, operating systems, system software or compute services interact with. Within this definition, server as used in the terms “client-server”, “multi-tier computing”, “3-tier computing”, network services or web services are included.

“Vendor” means a licensor of licensed software including its copyright owner and other parties granted a right by the copyright owner to sell or otherwise distribute licenses to Customers to use the licensed software.

“Vendor license server” means the server that resides at the vendor's site and is responsible for maintaining all the licenses for a given customer.

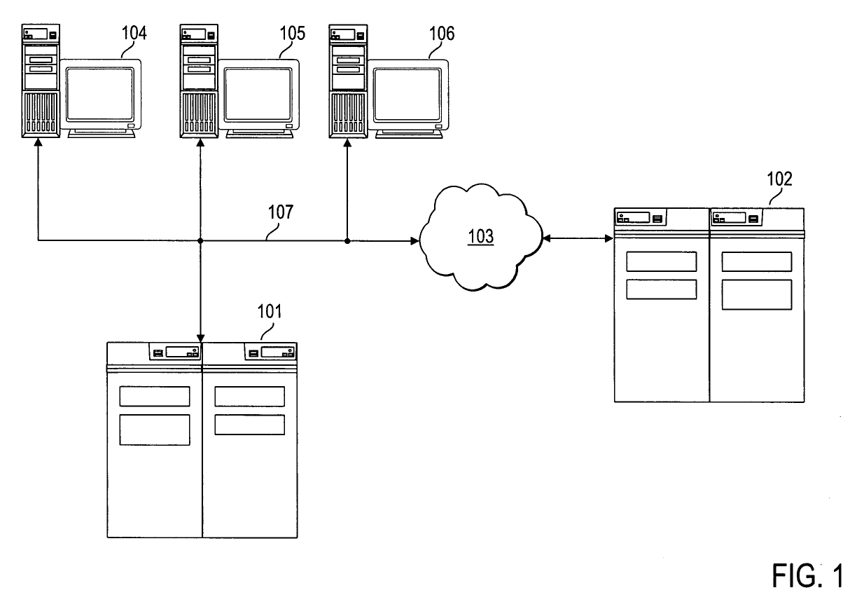

FIG. 1 illustrates a block diagram of an exemplary software license management system, according to one embodiment of the present invention. In addition to license management systems, it is to be appreciated that other systems employing the various teachings herein may also be used to practice the various aspects of the present invention, and as such, are considered to be within its full scope.

System 100 includes a front-end server 101 (also known as a primary license server) that is configurable to control usage of licensed software, and optionally, may also securely communicate with a back-end server 102 (also known as a vendor license server) available at a designated destination, such as via a direct dial-up telephone number, an Internet Uniform Resource Locator (URL), an email address or other networking address. The licensed software application is operative on various front-end computers (also known as clients) connected in a network 107, including the front-end server 101 and other computers represented as computers 104-106. System 100 represents one of many license management configurations, where clients 104-106 connect directly to the primary license server 101 to obtain licenses. Primary license server 101 includes license management software.

The network 107 may be a Local Area Network (LAN), Wide Area Network (WAN), Virtual Private Network (VPN), or other network that is managed or otherwise controlled by a customer of the licensed software. Communication between the front-end server 101, which preferably resides at a location designated or authorized by the customer of the licensed software, and the back-end server 102, which preferably resides at a location designated or authorized by a vendor of the licensed software, is performed through a communication medium 103, such as the Internet, a private network or a direct dial-up connection. In the case of the Internet, secure transmission of messaging is preferably performed, for example, using the Secure Sockets Layer protocol (SSL), and a Virtual Private Network (VPN).

Alternatively, any one or more of the front-end computers represented by front-end computers 104-106 on the network 107 may be configured, instead of or in addition to the front-end server 101, to control usage of its licensed software and/or the licensed software of other such computers, generate e-mail messages, and securely transmit the e-mail messages to the back-end server 102. Accordingly, as used herein and in the following claims, the term “front-end server” is understood to also include such front-end computers when performing such functions. In addition to certain of the front-end computers being configured to run the licensed application software, the front-end server 101 may also be so configured.

The back-end server 102 is configured to receive, authenticate, and process license management messages, the e-mail messages, and deliver the e-mail messages to the end recipient that could be an individual or software entity, such as business operations software. Examples of such business operations software include enterprise resource planning software (ERP), e-commerce software (such as those used for performing transactions over the Internet), customer relationship management software (CRM), and sales force automation software (SFA).

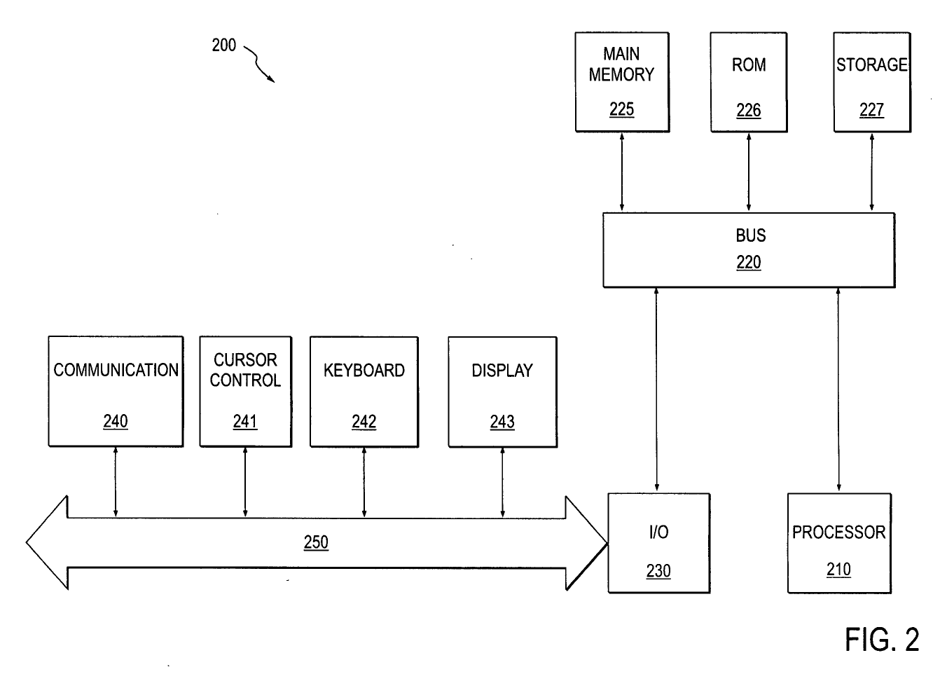

FIG. 2 illustrates an exemplary computer architecture for use with the present system, according to one embodiment of the invention. Computer architecture 200 can be used to implement both front-end computers (clients) 104-106, front-end servers 101, and back-end servers 102 of FIG. 1. One embodiment of architecture 200 comprises a system bus 220 for communicating information, and a processor 210 coupled to bus 220 for processing information. Architecture 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Architecture 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Architecture 200 can also be coupled to a second I/O bus 250 via an I/O interface 230. A plurality of I/O devices may be coupled to I/O bus 250, including a display device 243, an input device (e.g., an alphanumeric input device 242 and/or a cursor control device 241). For example, web pages and business related information may be presented to the user on the display device 243.

The communication device 240 allows for access to other computers (servers or clients) via a network. The communication device 240 may comprise a modem, a network interface card, a wireless network interface or other well known interface device, such as those used for coupling to Ethernet, token ring, or other types of networks.

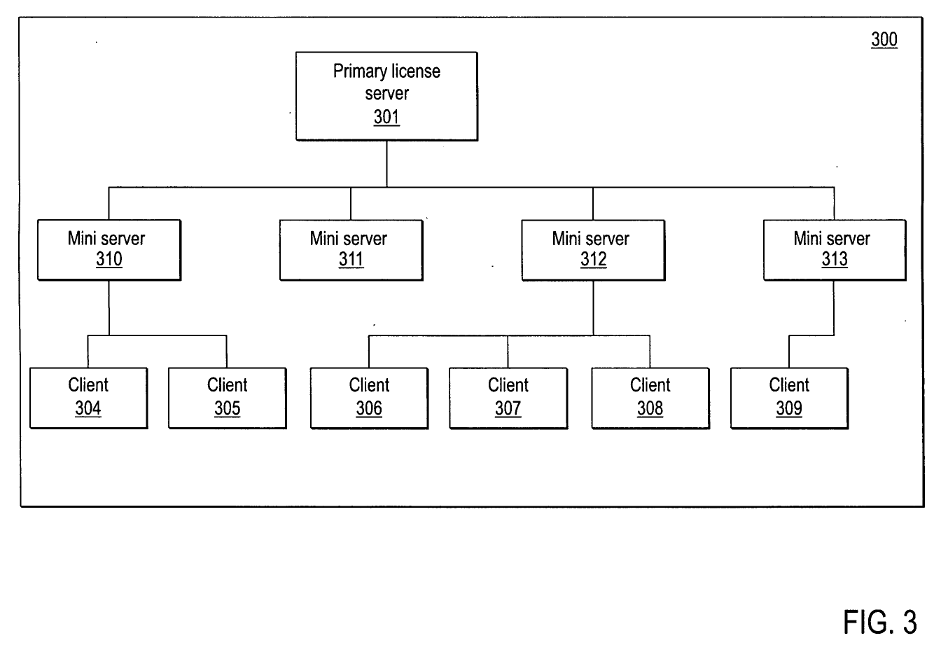

FIG. 3 illustrates a block diagram of an exemplary license server hierarchy 300 according to one embodiment of the present invention. License server hierarchy 300 includes a top-level primary license server 301 that reads license files and maintains the list of all licenses; mini-servers 310-313 serve the licenses to client applications; and clients 304-309 that are connected to the mini-servers 310-313. When the primary license server 301 starts up it will read the license files and maintain the list of all available licenses. In one embodiment, the primary license server 301 then waits for mini-servers 310-313 to connect to it. Since primary license server 301 reads the license files it will need to be licensed to run on a particular host. Additionally if the customer so desires, the primary license server 301 will be able to serve licenses to clients 304-309 directly.

According to one embodiment, on start-up each mini-server 310-313 will connect to the primary license server 301 to register its presence within the hierarchy 300. The primary license server 301 may issue, depending on its configuration, some portion of the total licenses available for a given feature to the requesting mini-server 310-313. These licenses will be held in memory in the mini server 310-313 so that they can be handed out to client applications as needed. When a mini server, for example mini server 313, runs out of licenses it requests more from the primary license server 301. If the primary license server 301 does not have any licenses available it will request that one of the other mini servers 310-312 return some number of un-used licenses. If there are no un-used licenses in any of the mini servers 310-312 then the checkout request from the client, such as client 309, may fail. The checkout request may also be queued, and processed at a later time.

Each mini server 310-313 updates the primary license server 301 regularly with usage information so the primary license server 301 can log it and track which clients 304-309 are connected to which mini server 310-313. In some configurations, licenses are checked out constantly. In one embodiment, so that the network is not flooded with usage data relating to the checked-out licenses, the usage data is batched, compressed, and then sent to the primary license server 301. Since the mini servers 310-313 communicate through the primary license server 301 the mini servers 310-313 do not need to communicate with each other. This allows the customers to maintain discrete networks but still maintain a single primary license server 301.

According to another embodiment, hierarchy 300 may be adapted to include redundant mini severs. If a mini server, for example mini server 312, goes down the clients, for example clients 306-308 connected to it will be able to connect to another mini server, for example, mini server 311 to obtain a license.

Primary license server 301 updates each mini server 310-313 with information about the other mini servers. Each mini server 310-313 in-turn updates its clients 304-309 with the information about the other mini servers 310-313. In case of a mini server 310-313 crash, or other failure, a client 304-309 can automatically switch to another mini server 310-313. The client 304-309 will cache the information about the other mini servers 310-313 so that the next time it starts up it can find an alternate mini server if it's preferred mini server is unavailable.

Depending on the license issued by the vendor, when a mini server 310-313 loses its connection to a primary license server 301 it may be configured to perform the following actions:

Continue serving currently connected clients 304-309 but not allow new license requests.

Continue serving its allocation of licenses for some period of time.

Quit and force clients 304-309 to connect to another mini server 310-313.

Quit and force clients 304-309 to quit.

Since the mini servers 310-313 do not read license files they do not need to be licensed to a specific host. This allows the customer to run any number of mini servers 310-313 it desires. In an alternate embodiment, a vendor may license the primary license server 301 such that it will only allow a specified number of mini-servers to connect to it.

A primary license server 301 maintains usage data so it can track which clients 304-309 are connected to which mini server 310-313. When a client, for example client 306, switches from mini server 312 to another mini server, for example mini server 311 because mini server 312 is no longer responding, the client 306 transmits a message to the new mini server 311 that it lost its connection to the previous mini server 312. This information is then sent to the Primary license server 301. At this point the primary license server 301 knows that it can remove this license from the disconnected mini server 312 and release it to the next mini server 311. The period of time that the primary license server 301 holds on to the licenses for the disconnected mini server 312 is determined by the vendor with the license they grant to the primary license server. This may be the same amount of time the mini server is allowed to serve licenses without a connection to its primary license server 301.

The present method and system allow for load balancing among mini-servers 310-313. The usage information that the primary license server 301 maintains is used to determine the load on each of the mini servers 310-313. This allow the primary license server to determine how to balance the client load on each of the mini servers 310-313. When the primary license server 301 determines that a mini server is at its maximum load, for example mini-server 312, it will send instructions to the mini-server 312 to re-direct clients 306-308 to another mini server, for example mini server 311.

Depending on the configuration, the maximum load may be based upon different indicators, some of which are listed here:
The maximum number of licenses the mini server 310-313 is configured for.
The number of license requests per second the mini server 310-313 is handling
An even division of the load between all mini servers 310-313.
Placement of the mini servers 310-313 in order so that all clients 304-309 are directed to the first mini server in the list until it has reached it's maximum load and then direct clients 304-309 to the next mini server, whether logical or physical.
Time of day.
   A local administrator may configure these parameters.

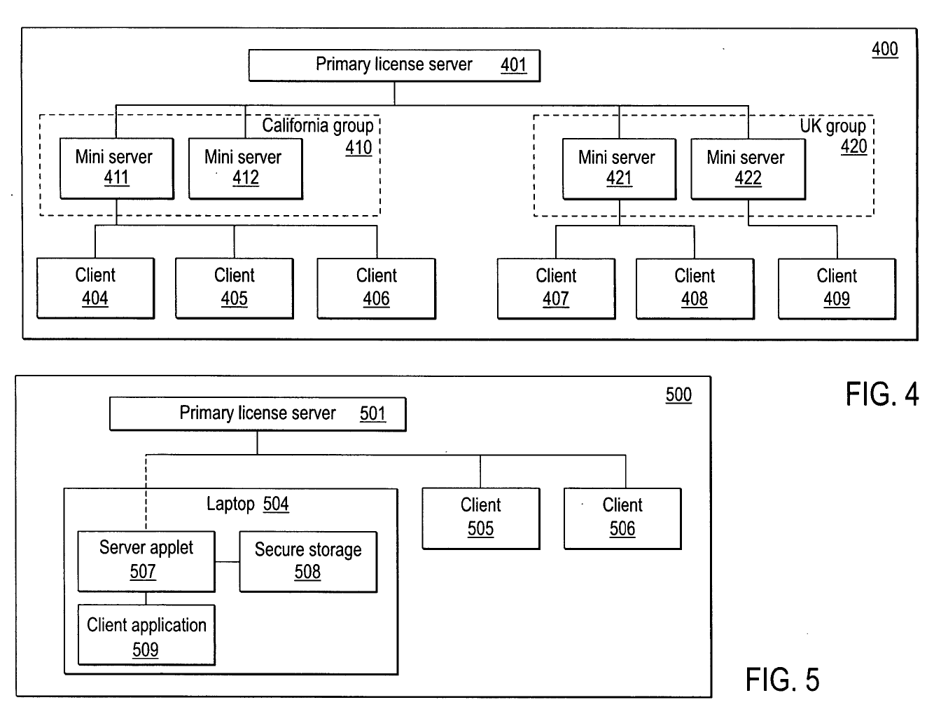

FIG. 4 illustrates a block diagram of an exemplary license server hierarchy 400 with mini-server groups, according to one embodiment of the present invention. License server hierarchy 400 includes mini server groups 410 and 420; mini servers 411, 412, 421, 422; and clients 404-409. The customer may configure mini servers 411-412, 421-422 into logical groups, for example California group 410 and UK group 420.

This provides a number of additional capabilities. The customer configures the primary license server 401 to define the maximum and minimum number of licenses allowed in any given group 410, 420 over some period of time. For example, if there is a company that has offices in California and the UK it makes sense to allocate most of the licenses to the UK during working hours there and then to allocate most of the licenses to California during working hours there. According to one embodiment, clients 404-409 are able to redirect to another mini server in the same group.

Regarding load balancing as described above, group identifiers are used for the mini servers 411, 412, 421, 422. The primary license server 401 only redirects clients, for example 404-406 to another mini server in the same group, for example mini server 412 in group 410. The local administrator has the ability to configure the group information and load balancing between mini servers 411, 412, 421, 422.

FIG. 5 illustrates a block diagram of an exemplary license borrowing system 500, according to one embodiment of the present invention. A license borrowing mechanism is needed when a client, for example laptop 504, disconnects from the primary license server, such as primary license server 501. License borrowing system 500 includes a primary license server 501, clients 505, 506, and a laptop 504. Laptop 504 includes a license server applet 507, secure storage 508, and a client application 509 that requires a license from primary license server 501. When a request to borrow a license occurs, the license applet 507 requests a borrowed license from either a mini server or primary server 501, depending on what it is connected to. The license applet 507 caches this license in an encrypted file or other secure storage 508. When the client application 509 runs it requests a license from the local license server, in this case the server applet 507.

If a license is borrowed from a mini server, the mini server transmits this usage information to the primary server, such as primary license server 501, so that if there is a server failure somewhere the borrow information is saved. Additionally, this allows the borrowed license to be returned to any mini server. In another embodiment, a client 504 maintains a constant borrowed license for some specified period of time. The vendor's licensing of the primary server 501 determines things like this along with the maximum and minimum borrow periods.

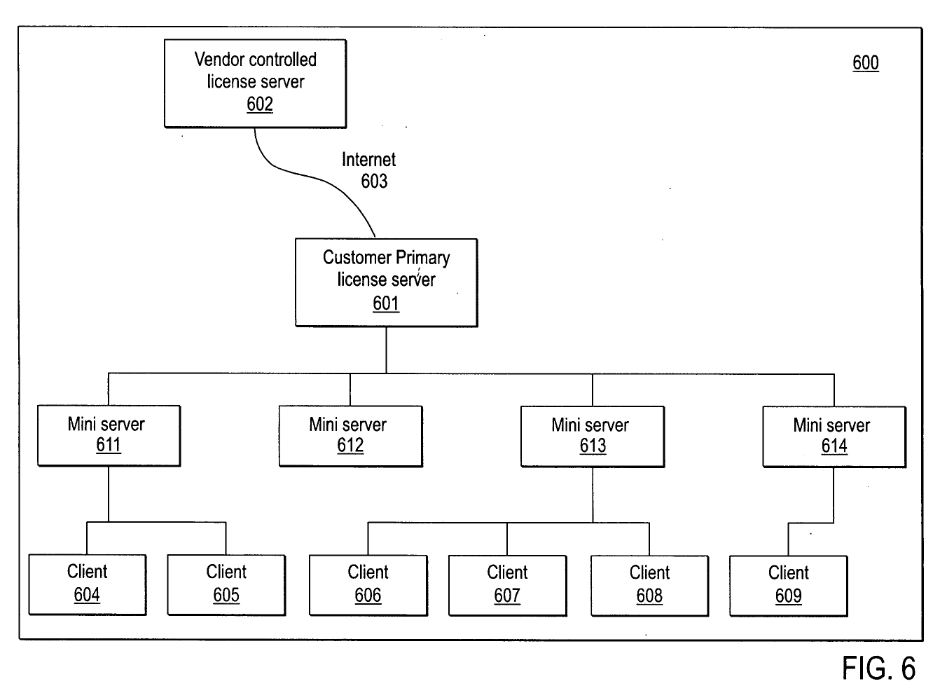

FIG. 6 illustrates a block diagram of a license server hierarchy 600 having a vendor controlled license server, according to one embodiment of the present invention. Hierarchy 600 includes clients 604-609, mini servers 611-614, customer primary license server 601, and a vendor controlled license server 602 connected by the Internet 603. The vendor license server 602 is under the control of the vendor. Whether the vendor license server 602 is at the vendor's site or not is unimportant. The primary license server 601 at the customer's site will connect to and retrieve its licenses from the vendor license server 602.

Depending on the vendor's licensing configuration, the primary server 601 at the customer's site caches licenses in an encrypted file or other secure storage. In event of a loss of communication between the primary server 601 and the vendor license server 602, the primary license server 601 can continue to serve licenses for some period of time. The customer's primary server 601 is unable to fulfill license requests if it is not in communication with the vendor license server 602 for some period of time specified by the vendor.

A vendor controlled license server 602 provides numerous benefits for the vendor. For example:
the vendor has full control over the issuance and storage of licenses;
customers do not see a text version of the license, minimizing customer license tampering;
hackers are deterred from creating counterfeit licenses;
licenses can be revoked if the vendor misses a payment;
a reduced support load for license administration at the customer site;
re-hosting the primary license server 601 is facilitated; and
full-feature usage information is available to the vendor, including usage based licensing and secure billing.

A vendor controlled license server 602 provides numerous benefits for the customer as well. For example:
the customer need not worry about license management including license keys or license files;
re-hosting the primary license server 601 is facilitated;
problems with redundant servers are alleviated;
license retrieval is automated so that if a feature is requested by a client that the primary server 601 does not know about, the primary server 601 can contact the vendor server 602 and download the feature.

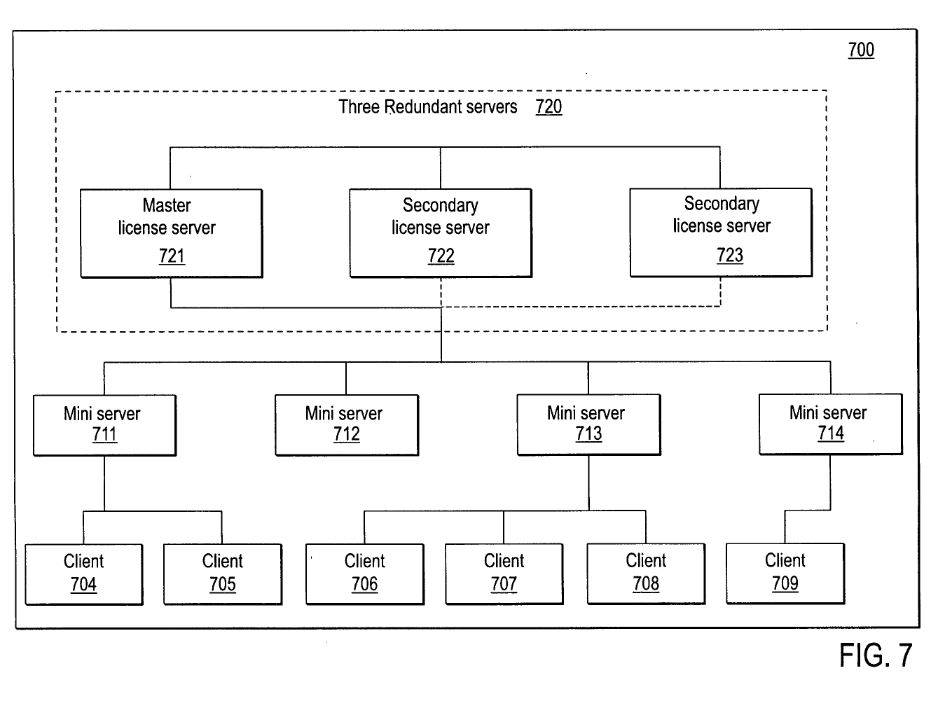

FIG. 7 illustrates a block diagram of an exemplary redundant server architecture 700, according to one embodiment of the present invention. Redundant servers may be dongle based, a 3-server redundancy scheme, redundancy with a connection to a vendor license server, or other similar redundancy mechanisms. Redundant server architecture 700 includes three redundant servers 721-723, connected to mini servers 711-714 that are connected to clients 704-709. When redundant servers 720 start up they exchange information with each other. As mini severs 711-714 or clients 704-709 connect to one of these redundant servers 720 they are given all the information about all possible redundant servers 720 along with the current master license server 721. If a mini server 711-714 or client 704-709 is not currently connected to the master license server 721 it will be redirected to the master license server 721.

According to one embodiment, only the master license server 721 distributes licenses. The secondary license servers 721-723 are regularly updated by the master license server 721 to mirror the current state of master license server 721. If master license server 721 crashes then the remaining secondary license servers 712-713 negotiate between themselves to determine which will be the new master license server. If the master license server 721 goes down or loses communication, then a client 704-709 or mini server 711-714 having detected the lost connection to the master server 721 redirects traffic to one of the secondary license servers 722-723, such that license checkouts continue uninterrupted.

Architecture 700 includes three primary license servers 720, of which one is designated the master license server 721 and the other two are the secondary mirrored license servers 722-723. The license issued by the vendor includes the host ids from all three license servers 720. At least two of the three redundant servers 720 must be running and communicating with each other to serve licenses to the mini servers 711-714 or clients 704-709.

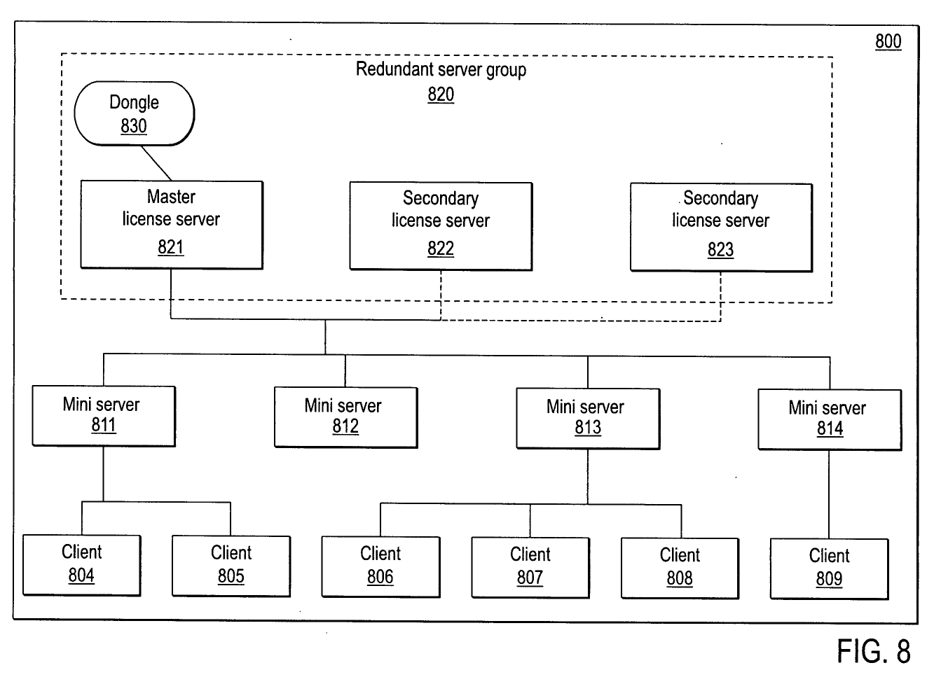

FIG. 8 illustrates a block diagram of an exemplary redundant server architecture 800 having a dongle 830, according to one embodiment of the present invention. With the use of a dongle 830 a customer can run any number of primary license servers 821-823 where only the server with the dongle 830 is the master license server 821 and distributes licenses to the mini servers 811-814 or clients 804-809. The other secondary license servers 822-823 act as mirrors of the master license server 821 and do not grant licenses.

If a mini server 811-814 or client 804-809 loses its connection to the master license server 821 with the dongle 830, it connects to one of the secondary license servers 822-823. Depending on how the vendor licenses the redundant server configuration they may allow a secondary license server 822-823 without the dongle 830 to server licenses for some short period of time to allow the dongle 830 to be moved without interruption in service.

When the dongle 830 is connected to one of the secondary license servers 822-823 the secondary license server, for example server 822, becomes the new master and communicates that information to the other secondary servers, for example server 823. Since the new master 822 was mirrored from the original master 821 it has all the connection and usage information. The new master 822 can connect to each mini server 811-814 to tell it which server is the new master.

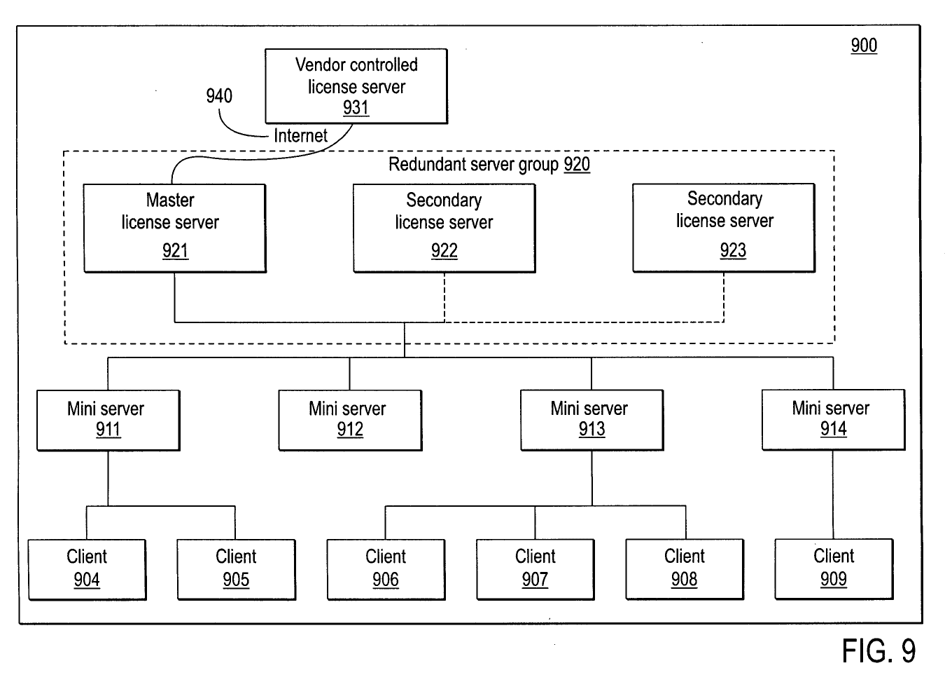

FIG. 9 illustrates a block diagram of an exemplary redundant server architecture 900 having a vendor license server 931, according to one embodiment of the present invention. Redundant server architecture 900 includes vendor controlled license server 931, redundant server group 920, mini servers 911-914, and clients 904-909. The vendor controlled license server 931 and redundant server group 920 are connected via the Internet 940. Architecture 900 is similar to architecture 800 that uses a dongle. Primary master license server 921 downloads licenses from the vendor license server 931 and any number of secondary mirrored servers at the customer's site. If the master license server 921 goes down then one of the secondary license servers 922 becomes the master and connects to the vendor license server 931 to verify the licenses and then grants license requests. The master license server 921 may be granted a license by the vendor license server 931 to run for some period of time if it loses communication with the vendor license server 931.

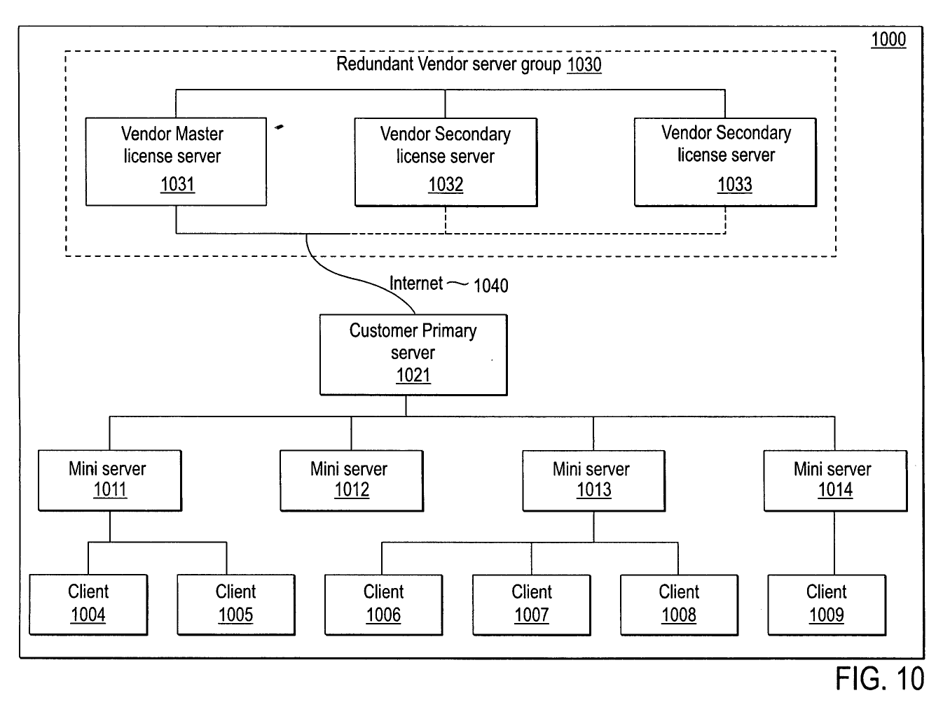

FIG. 10 illustrates a block diagram of an exemplary redundant server architecture 1000 having a redundant vendor server group 1030, according to one embodiment of the present invention. Architecture 1000 includes redundant vendor server group 1030, customer primary license server 1021, mini servers 1011-1014, and clients 1004-1009. The redundant server group 1030 is connected to the customer primary server 1021 via the Internet 1040. Redundant vendor server group 1030 includes one master vendor license server 1031 that fulfills requests from a customer primary license server 1021 and some number of mirrored secondary vendor license servers 1032-1033.

The vendor maintains multiple redundant servers 1032-1033 to guarantee uptime to its customers. Since the vendor secondary license servers 1022-1023 are under the control of the vendor, a redundant vendor server group 1030 is easier to maintain than maintaining redundant servers at a customer site. When a customer primary license server 1021 loses its connection to the vendor master license server 1031 it connects to the vendor's secondary license server (for example vendor secondary license server 1032) to continue issuing licenses.

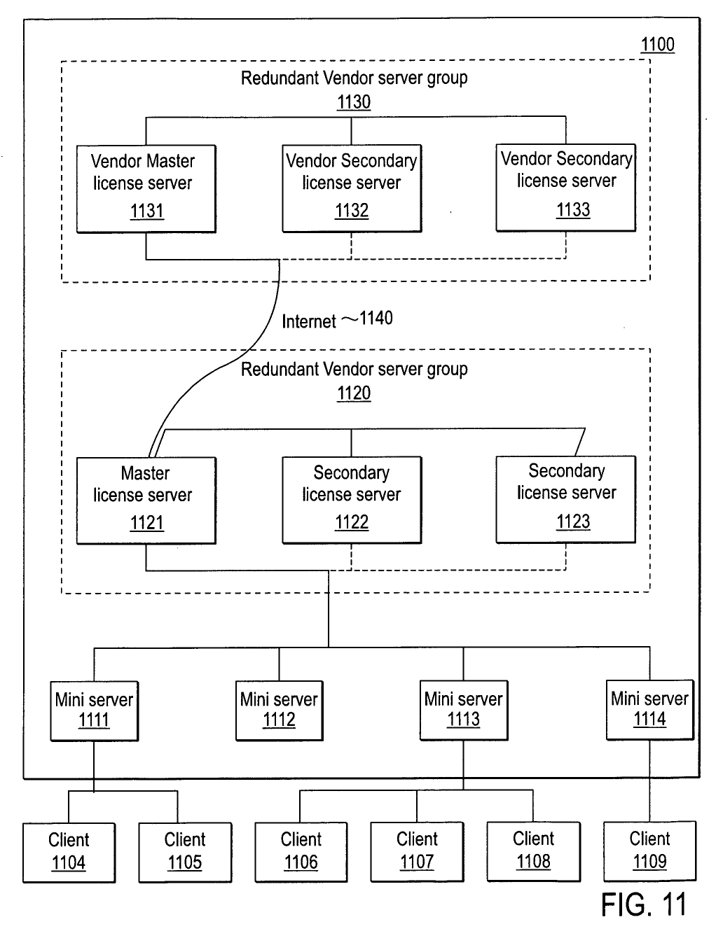

FIG. 11 illustrates a block diagram of an exemplary redundant server architecture 1100 having a redundant vendor server group 1130 and a redundant customer license server group 1120, according to one embodiment of the present invention. Unlike architecture 1000 of FIG. 10 that shows a single primary server 1021 connected to the vendor master license server 1031 of the redundant server group 1030, architecture 1100 illustrates the master customer license server 1121 of a primary redundant server group 1120 configuration communicating with a vendor master license server 1131 of the vendor redundant server group 1130.

There are a number of methods that allow a client, such as clients 1104-1109 to find the various mini servers (for example mini servers 1111-1114) and for the mini servers (e.g., mini servers 1111-1114) to find the primary master license server (for example, primary master license server 1121). The following are examples of methods:
The client is configured with the necessary information to find the mini servers.
A broadcast message is sent that the server replies to.
Directory services on Windows.
Hard coding a default host name, such as ‘licenseserver’ to look for in the absence of other configuration information. The customer can setup a DNS entry for this on their network. The host name is configurable by the vendor.
The primary server is configured to be the repository of all configuration and address information.
   For the client the primary server sends the information about all the mini servers. The client caches this information for later use.
   For the mini servers the primary servers are configured to know about all the mini servers used so that the primary server connects to the mini servers. The primary server sends the information about all the other mini servers to the connected mini server. This method allows the customer to manage its configuration as only one system is configured.
Dynamic redirection, such that if a client connects to a primary or mini server, either of the servers may redirect the client to another server. Additionally a mini server will be able to re-direct a client at any time during a session. Redirection allows support of the graceful shutdown of a mini server as well as load balancing.

According to one embodiment, a license server as described above may be implemented as a network appliance. The hierarchical servers described above allow for a network appliance to be used as the primary or a mini server. The network appliance is an embedded LINUX box, for example perhaps with a web interface for configuration. The encrypted licenses would be stored in flash RAM making it much harder for a hacker to see what is going on. The customer does not need to do anything with license files or license servers. Just “plug and play”.

A license server network appliance is pre-loaded with the necessary licenses. The licensing appliance is used as a secure primary license server. When shipped from the vendor it knows the address of the vendor's license server and when booted up it automatically connects to the vendor license server and downloads the licenses. The customer uses the web interface to manually configure the licenses or connect to the vendor's license server. A few appliances are plugged into a network to act as load balanced mini servers.

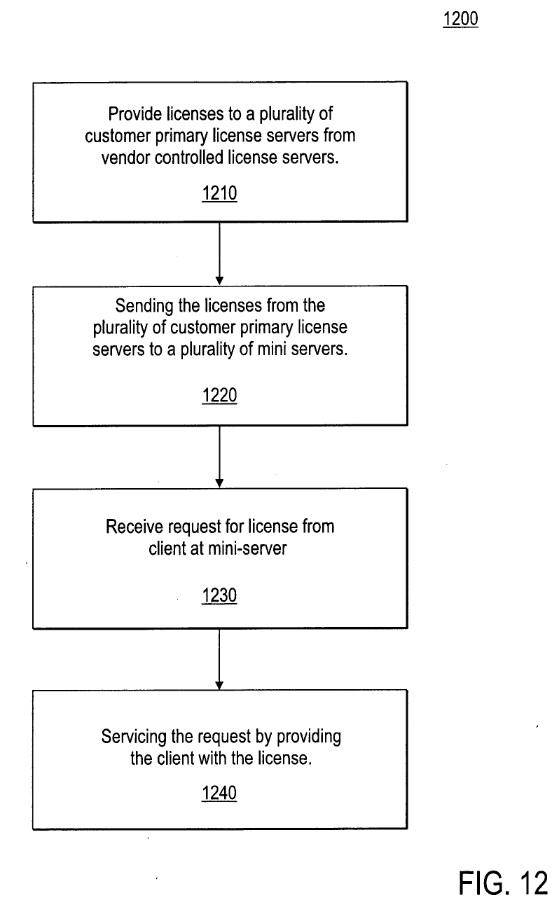

FIG. 12 illustrates a flow chart of an exemplary process 1200 for hierarchical license serving, according to one embodiment of the present invention. Process 1200 allows for vendor controlled license servers to provide licenses to a plurality of customer primary license servers. (1210) The licenses are sent from the plurality of customer primary license servers to a plurality of mini servers. (1220) A mini-server receives a request for a license from a client. (1230) The request is served by the mini server by providing the client with the license. (1240)

A method and system for hierarchical license servers has been disclosed. Although the present methods and systems have been described with respect to specific examples and subsystems, it will be apparent to those of ordinary skill in the art that it is not limited to these specific examples or subsystems but extends to other embodiments as well.

I claim:

1. A computer-implemented method, comprising:
receiving license requests from a plurality of clients;
servicing the license requests using a plurality of mini servers, each mini server serving licenses to a client of the plurality of clients in response to a license request of the license requests; and
providing the plurality of mini servers with the licenses from a primary license server.

2. The computer-implemented method of claim 1, further comprising grouping the plurality of mini servers into a plurality of logical groups.

3. The computer-implemented method of claim 1, further comprising providing the primary license server with the licenses from a vendor controlled license server.

4. The computer-implemented method of claim 3, wherein the primary license server is a master license server belonging to a plurality of primary license servers.

5. The computer implemented method of claim 4, further comprising providing a dongle connected to the master license server.

6. The computer implemented method of claim 4, further comprising providing a vendor controlled license server connected to the master license server.

7. The computer implemented method of claim 6, wherein the vendor controlled license server is a master vendor license server belonging to a plurality of redundant vendor license servers.

8. A computer-readable medium having stored thereon a plurality of instructions, said plurality of instructions when executed by a computer, cause said computer to perform:
receiving license requests from a plurality of clients;
servicing the license requests using a plurality of mini servers, each mini server serving licenses to a client of the plurality of clients in response to a license request of the license requests; and
providing the plurality of mini servers with the licenses from a primary license server.

9. The computer-readable medium of claim 8 having stored thereon-additional instructions, said additional instructions when executed by a computer, cause said computer to further perform grouping the plurality of mini servers into a plurality of logical groups.

10. The computer-readable medium of claim 8 having stored thereon-additional instructions, said additional instructions when executed by a computer, cause said computer to further perform providing the primary license server with the licenses from a vendor controlled license server.

11. The computer-readable medium of claim 10, wherein the primary license server is a master license server belonging to a plurality of primary license servers.

12. The computer-readable medium of claim 11 having stored thereon-additional instructions, said additional instructions when executed by a computer, cause said computer to further perform providing a dongle connected to the master license server.

13. The computer-readable medium of claim 11 having stored thereon-additional instructions, said additional instructions when executed by a computer, cause said computer to further perform providing a vendor controlled license server connected to the master license server.

14. The computer-readable medium of claim 13, wherein the vendor controlled license server is a master vendor license server belonging to a plurality of redundant vendor license servers.

15. A computer, comprising:
a processor;
a bus connected to the processor; and
a memory connected to the bus, the memory storing instructions;
wherein the instructions when executed by the processor cause the processor to,
receive a license request from a clients of a plurality of clients;
service the license request, comprising receiving a license from a primary license server; and
communicate with a plurality of mini servers, the plurality of mini servers serving licenses to the plurality of clients and receiving the licenses from the primary license server.

16. A computer, comprising:
a processor;
a bus connected to the processor; and
a memory connected to the bus, the memory storing instructions;
wherein the instructions when executed by the processor cause the processor to,
communicate with a plurality of mini servers, the plurality of mini servers serving licenses to a plurality of clients; and
providing the licenses to the plurality of mini servers.

17. The computer of claim 16, wherein the instructions when executed by the processor cause the processor to receive the licenses from a vendor controlled license server.

18. A computer, comprising:
a processor;
a bus connected to the processor; and
a memory connected to the bus, the memory storing instructions;
wherein the instructions when executed by the processor cause the processor to,
request a license from a mini server of a plurality of mini servers, the plurality of mini servers receive licenses from a primary license server.
